(19) United States
(12) Patent Application Publication
(10) Pub. No.: US 2026/0023348 A1
(43) Pub. Date: Jan. 22, 2026

(54) TIME MEASUREMENT DEVICE

(71) Applicant: SEIKO WATCH KABUSHIKI KAISHA (trading as SEIKO WATCH CORPORATION), Tokyo (JP)

(72) Inventors: Tomohiro IHASHI, Tokyo (JP); Kazuo Kato, Tokyo (JP)

(21) Appl. No.: 19/265,672

(22) Filed: Jul. 10, 2025

(30) Foreign Application Priority Data
Jul. 17, 2024 (JP) 2024-113860

(51) Int. Cl. G04G 9/12

(52) U.S. Cl. CPC G04G 9/12

(57) ABSTRACT

To prevent, with a simple configuration, a timing at which a polarity of an AC voltage applied to a liquid crystal panel is reversed at a constant polarity reversal cycle and a timing at which image data is written to the liquid crystal panel from overlapping each other. A time measurement device includes: an event holding unit configured to hold an event in periods of a certain first standby operation time immediately before the polarity of the AC voltage applied to the liquid crystal panel is reversed and a certain second standby operation time immediately after the polarity of the AC voltage is reversed; a display update determination unit configured to determine whether the holding event requires updating of the display on the liquid crystal panel after the periods of the first standby operation time and the second standby operation time elapse; and an image data output control unit configured to write, to the liquid crystal panel, image data of the event for which a determination is made that the updating of the display on the liquid crystal panel is required.

### RELATED APPLICATIONS

This application claims priority to Japanese Patent application No. JP2024-113860, filed on Jul. 17, 2024, the entire content of which is incorporated herein by reference.

### BACKGROUND OF THE INVENTION

### 1. Field of the Invention

The present invention relates to a time measurement device.

### 2. Description of Related Art

In the related art, for example, in a liquid crystal panel provided in a digital electronic timepiece or the like, in order to maintain reliability of a liquid crystal, it is recommended to apply an AC voltage, a polarity of which is reversed at a constant cycle, to the liquid crystal panel from outside the liquid crystal panel. In addition, it is recommended that a time proportion between a period in which the AC voltage is positive and a period in which the AC voltage is negative (positive and negative periods of the AC voltage) is 50% each (duty ratio: 50%). Meanwhile, if a timing at which the polarity of the AC voltage is reversed overlaps a timing at which image data to be displayed on the liquid crystal panel is written to the liquid crystal panel, the image data may not be written normally due to an influence of an increase in an electrical load or the like. As a related art for coping with this problem, for example, PTLs 1-3 are known.

According to a technique disclosed in PTL 1, a polarity of an AC voltage is reversed at a constant cycle shifted from a reference time by a certain time, and when it is determined that a period for transferring image data is in a transfer standby period for reversing the polarity of the AC voltage, the image data is transferred after the transfer standby period elapses.

In a technique disclosed in PTL 2, a polarity of an AC voltage is reversed at a constant polarity reversal cycle, and image data is output at a cycle that is synchronized with the polarity reversal cycle and is an integer multiple of the polarity reversal cycle.

In a technique described in PTL 3, when an enable signal for writing image data and a timing of polarity reversal of an AC voltage overlap each other, the polarity reversal of the AC voltage is delayed during an output of the enable signal, and the output of the enable signal is delayed during the polarity reversal of the AC voltage.

### 3. Citations

### Patent Literature

Patent Literature: [PTL 1] JP5450784B
Patent Literature: [PTL 2] JP6866817B
Patent Literature: [PTL 3] JP7187792B

### SUMMARY OF THE INVENTION

However, in the technique described in PTL 1, since it is necessary to perform processing for determining whether a period for transferring the image data is in the transfer standby period for reversing the polarity of the AC voltage, software becomes complicated.

In the technique described in PTL 2, a period in which the display is updated in synchronization with the polarity reversal cycle, such as a time point on a clock, is preferable, but when the display is updated asynchronously with the polarity reversal cycle due to a button operation or the like by a person, a timing of the polarity reversal of the AC voltage and a timing of a display update, that is, a timing of an output of the image data may overlap.

In the technique described in PTL 3, since the polarity reversal of the AC voltage is delayed during the output of the enable signal, a duty ratio 50% of positive and negative periods of the AC voltage cannot be maintained.

The invention is made in consideration of the above circumstances, and an object of the invention is to prevent, with a simple configuration, a timing at which a polarity of an AC voltage applied to a liquid crystal panel is reversed at a constant polarity reversal cycle and a timing at which image data is written to the liquid crystal panel from overlapping each other.

According to one aspect of the invention, there is provided a time measurement device having a time measurement function and displaying an image on a liquid crystal panel by writing image data to the liquid crystal panel. The time measurement device includes: a polarity control unit configured to reverse a polarity of an AC voltage applied to the liquid crystal panel at a constant polarity reversal cycle; an event reception unit configured to receive an event that has a possibility to cause an update of a display on the liquid crystal panel; an event holding unit configured to hold the event received by the event reception unit in periods of a certain first standby operation time immediately before the polarity of the AC voltage is reversed and a certain second standby operation time immediately after the polarity of the AC voltage is reversed; a display update determination unit configured to determine whether the holding event requires updating of the display on the liquid crystal panel after the periods of the first standby operation time and the second standby operation time elapse; and an image data output control unit configured to write, to the liquid crystal panel, image data of the event for which the updating of the display on the liquid crystal panel is determined to be required. The first standby operation time includes one unit of time for writing the image data to the liquid crystal panel and an image data writing inhibition time immediately before the polarity of the AC voltage is reversed, and the second standby operation time includes an image data writing inhibition time immediately after the polarity of the AC voltage is reversed.

According to one aspect of the invention, in the time measurement device, the image data output control unit writes, to the liquid crystal panel after the period of the second standby operation time elapses, a portion not being completely written to the liquid crystal panel by an end of the period of the first standby operation time among the image data of the event for which the updating of the display on the liquid crystal panel is determined to be required.

According to one aspect of the invention, in the time measurement device, among the image data of the event for which the updating of the display on the liquid crystal panel is determined to be required, a portion of the image data in which writing to the liquid crystal panel is completed by the end of the period of the first standby operation time and a portion of the image data to be written to the liquid crystal panel after the period of the second standby operation time elapses are written to different addresses in the liquid crystal panel.

According to one aspect of the invention, in the time measurement device, among the image data of the event for which the updating of the display on the liquid crystal panel is determined to be required, a portion of the image data in which writing to the liquid crystal panel is completed by the end of the period of the first standby operation time and a portion of the image data to be written to the liquid crystal panel after the period of the second standby operation time elapses are displayed in different parts on a display region of the liquid crystal panel.

According to one aspect of the invention, in the time measurement device, the event is a request for predetermined processing inside the time measurement device that occurs after communication from a control unit having a predetermined control function inside the time measurement device is received inside the time measurement device.

According to one aspect of the invention, in the time measurement device, the event is a request for predetermined processing activated by a hardware interrupt that occurs inside the time measurement device to a control unit having a predetermined control function inside the time measurement device.

According to one aspect of the invention, in the time measurement device, the event is a request to update a display of a time measured inside the time measurement device.

According to one aspect of the invention, in the time measurement device, the event is a request to update a display of a time point measured inside the time measurement device.

According to one aspect of the invention, in the time measurement device, the polarity reversal cycle is a non-integer multiple of a constant cycle at which the display on the liquid crystal panel is updated due to a specific function of the time measurement device.

According to one aspect of the invention, in the time measurement device, the event is a request for predetermined processing for each operated button in the time measurement device after an operation of the button is received.

According to one aspect of the invention, in the time measurement device, the event is a request for predetermined processing inside the time measurement device that occurs after communication from a device outside the time measurement device is received inside the time measurement device.

According to one aspect of the invention, in the time measurement device, the event is a request for predetermined processing that occurs along with a change in an internal or external state of the time measurement device.

According to one aspect of the invention, in the time measurement device, the writing of the image data to the liquid crystal panel is performed by transmitting an address indicating a display position on the liquid crystal panel, transmitting the image data, and transmitting a write command once or repeatedly a plurality of times as one write operation, and by continuously performing the one write operation a plurality of times, the image data to be simultaneously displayed in a display region of the liquid crystal panel is written, and when a timing for reversing the polarity of the AC voltage arrives during the one write operation that is continuously performed a plurality of times, the one write operation currently performed is completed, and the remaining one or more of the one write operations are performed after the period of the second standby operation time elapses.

According to one aspect of the invention, in the time measurement device, the time measurement device is provided in a digital electronic timepiece, a combination timepiece having a digital display function and a pointer display function, a stopwatch, or a timer.

According to the invention, it is possible to prevent, with a simple configuration, a timing at which the polarity of the AC voltage applied to the liquid crystal panel is reversed at a constant polarity reversal cycle and a timing at which image data is written to the liquid crystal panel from overlapping each other.

### BRIEF DESCRIPTION OF THE DRAWINGS

FIG. 1 is a block diagram illustrating a configuration example of a time measurement device according to an embodiment;

FIG. 2 is a time chart illustrating an operation example of the time measurement device according to the embodiment;

FIG. 3 is a time chart illustrating an operation example of the time measurement device according to the embodiment;

FIG. 4 is a time chart illustrating an operation example of the time measurement device according to the embodiment;

FIG. 5 is a time chart illustrating an operation example of the time measurement device according to the embodiment;

FIG. 6 is a time chart illustrating an operation example of the time measurement device according to the embodiment;

FIG. 7 is a diagram illustrating a processing flow executed by the time measurement device according to the embodiment;

FIG. 8 is a diagram illustrating a processing flow executed by the time measurement device according to the embodiment;

FIG. 9 is a diagram illustrating a processing flow executed by the time measurement device according to the embodiment;

FIG. 10 is a diagram illustrating a processing flow executed by the time measurement device according to the embodiment;

FIG. 11 is a diagram illustrating a processing flow executed by the time measurement device according to the embodiment;

FIG. 12 is a diagram illustrating a processing flow executed by the time measurement device according to the embodiment;

FIG. 13 is a diagram illustrating a processing flow executed by the time measurement device according to the embodiment;

FIG. 14 is a diagram illustrating a processing flow executed by the time measurement device according to the embodiment;

FIG. 15 is a diagram illustrating a processing flow executed by the time measurement device according to the embodiment; and

FIG. 16 is a diagram illustrating a processing flow executed by the time measurement device according to the embodiment.

### DETAILED DESCRIPTION OF THE PREFERRED EMBODIMENTS

Hereinafter, an embodiment of the invention will be described with reference to drawings.

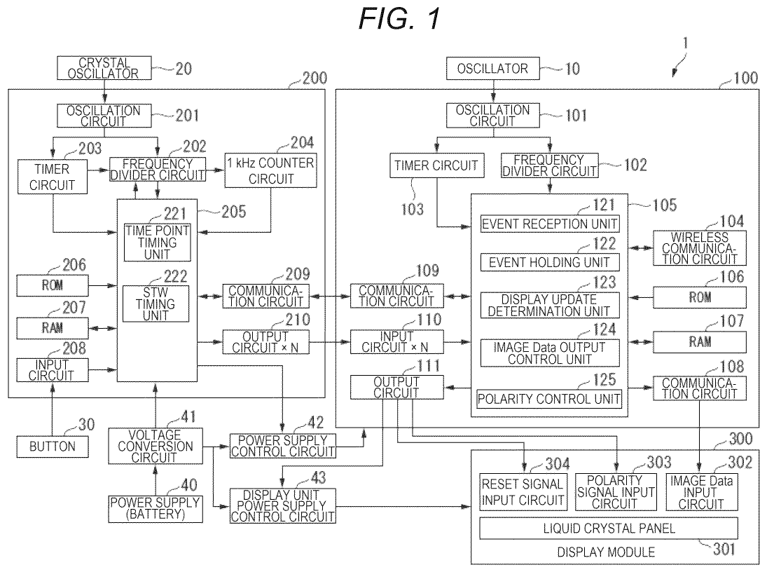

FIG. 1 is a block diagram illustrating a configuration example of a time measurement device 1 according to the embodiment. The time measurement device 1 includes an oscillator 10, a crystal oscillator 20, a first control device 100, a second control device 200, a display module 300, a button 30, a power supply (battery) 40, a voltage conversion circuit 41, a power supply control circuit 42, and a display unit power supply control circuit 43.

The first control device 100 mainly controls the display module 300. The second control device 200 mainly measures a time. The oscillator 10 generates a signal having a frequency which is the basis of an operation frequency of the first control device 100. The oscillator 10 may be a crystal oscillator or an oscillator of a type other than the crystal oscillator. The crystal oscillator 20 generates a signal having a frequency which is the basis of an operation frequency of the second control device 200. The frequency of the signal generated by the crystal oscillator 20 is, for example, 32.768 kHz.

The display module 300 includes a liquid crystal panel 301, an image data input circuit 302, a polarity signal input circuit 303, and a reset signal input circuit 304.

The liquid crystal panel 301 displays image data written from the first control device 100 via the image data input circuit 302. In a display region of the liquid crystal panel 301, a plurality of pixels for displaying an image are arranged. Each pixel is provided with a storage element that stores image data and a display element that displays the image data stored in the storage element. The liquid crystal panel 301 is a so-called memory in pixel (MIP) liquid crystal.

The polarity signal input circuit 303 receives a polarity reversal signal (VCOM signal) from the first control device 100. The VCOM signal is a signal indicating a reversal timing at which a polarity of an AC voltage applied to the liquid crystal panel 301 is reversed at a constant cycle. The AC voltage whose polarity is reversed at the reversal timing indicated by the VCOM signal is applied to the liquid crystal panel 301. Accordingly, an AC voltage whose polarity is reversed at a constant cycle is applied to the liquid crystal panel 301. This contributes to maintaining reliability of a liquid crystal of the liquid crystal panel 301.

In the VCOM signal, a time proportion of a period in which the AC voltage is positive and a period in which the AC voltage is negative (positive and negative periods of the AC voltage) is preferably 50% each (duty ratio 50%). Since the duty ratio of the positive and negative periods of the AC voltage of the VCOM signal is 50%, the AC voltage whose polarity is reversed at the duty ratio 50% during the positive and negative periods of the AC voltage is applied to the liquid crystal panel 301. This contributes to maintaining reliability of a liquid crystal of the liquid crystal panel 301.

The reset signal input circuit 304 receives a reset signal for resetting the display module 300 from the first control device 100. The display module 300 is reset by the reset signal received by the reset signal input circuit 304.

The button 30 is a button operated by a user. The user can cause the time measurement device 1 to perform a predetermined operation by operating the button 30.

The power supply 40 supplies power consumed by the time measurement device 1. The voltage conversion circuit 41 converts a voltage of the power supply 40 into an operation voltage (for example, 3.3 V) of the first control device 100, the second control device 200, and the display module 300. The power supply control circuit 42 controls a power supply to the first control device 100. The display unit power supply control circuit 43 controls a power supply to the display module 300. The power supply 40 is, for example, a coin lithium battery (CR battery: 3 V). The voltage conversion circuit 41 is implemented by a self-oscillation type DCDC conversion circuit using an inductor or a charge pump type boost circuit using a capacitor.

The first control device 100 includes an oscillation circuit 101, a frequency divider circuit 102, a timer circuit 103, a wireless communication circuit 104, a first control unit 105, a read only memory (ROM) 106, a random access memory (RAM) 107, communication circuits 108, 109, N input circuits 110, and an output circuit 111.

The oscillation circuit 101 generates a signal having a predetermined frequency based on a signal having a frequency generated by the oscillator 10. The frequency divider circuit 102 divides the signal having the predetermined frequency generated by the oscillation circuit 101 to generate a signal having an operation frequency of the first control unit 105. The timer circuit 103 uses the signal having the predetermined frequency generated by the oscillation circuit 101 to measure a predetermined timer time. The timer circuit 103 generates a hardware interrupt “timer interrupt” to the first control unit 105 at the time of completion of measurement of the predetermined timer time.

The wireless communication circuit 104 performs wireless communication with a device outside the time measurement device 1.

The first control unit 105 mainly has a function of controlling the display module 300 among control functions of the time measurement device 1. The first control unit 105 includes a central processing unit (CPU) and achieves various functions by executing programs stored in the ROM 106. The first control unit 105 includes, as functional units thereof, an event reception unit 121, an event holding unit 122, a display update determination unit 123, an image data output control unit 124, and a polarity control unit 125.

The ROM 106 stores programs executed by the CPU of the first control unit 105 and data such as default values of various parameters. The RAM 107 is a memory for temporarily storing data used by the first control unit 105.

The communication circuit 108 communicates with the display module 300 to write image data to the liquid crystal panel.

The communication circuit 109 communicates with the second control device 200. The communication circuit 109 receives, for example, timing data from the second control device 200.

The input circuit 110 receives a signal output from a corresponding output circuit 210 of the second control device 200. For example, a certain input circuit 110 receives a display update timing signal output from the corresponding output circuit 210 of the second control device 200. For example, a certain input circuit 110 receives a button input notification signal output from the corresponding output circuit 210 of the second control device 200.

The output circuit 111 transmits the VCOM signal to the display module 300. The output circuit 111 transmits a reset signal to the display module 300. The output circuit 111 transmits a signal for controlling a power supply of the display module 300 to the display unit power supply control circuit 43.

The polarity control unit 125 reverses the polarity of the AC voltage applied to the liquid crystal panel 301 at a constant polarity reversal cycle (for example, 0.99 seconds) based on an interrupt signal from the timer circuit 103. Further, the polarity control unit 125 may reverse the AC voltage applied to the liquid crystal panel 301 at a duty ratio 50% in the positive and negative periods. The polarity control unit 125 transmits the VCOM signal to the display module 300 by the output circuit 111. For example, the polarity control unit 125 transmits, to the display module 300 by the output circuit 111, the VCOM signal for reversing the polarity of the AC voltage to be applied to the liquid crystal panel 301 at a constant polarity reversal cycle and at the duty ratio 50% in the positive and negative periods of the AC voltage.

The event reception unit 121 receives an event that may cause an update of the display on the liquid crystal panel 301.

For example, the event is a request for predetermined processing inside the time measurement device 1 that occurs after communication from a control unit having a predetermined control function inside the time measurement device 1 is received inside the time measurement device 1. Examples of the control unit having a predetermined control function inside the time measurement device 1 include a second control unit 205 to be described later. The second control unit 205 has a function of controlling time measurement (a time point timing unit 221 and a stopwatch (STW) timing unit 222). For example, the event is a request for time update processing that occurs after the first control unit 105 receives a notification of time point update from the time point timing unit 221.

For example, the event is a request for predetermined processing activated by a hardware interrupt that occurs inside the time measurement device 1 to a control unit having a predetermined control function inside the time measurement device 1. Examples of the control unit having the predetermined control function inside the time measurement device 1 include the second control unit 205 (the time point timing unit 221 and the STW timing unit 222). For example, the event is a request for processing of updating the display of the stopwatch time point, which is activated by a hardware interrupt (for example, an interrupt signal having a predetermined frequency such as 1 Hz or 10 Hz) generated to the STW timing unit 222.

For example, the event is a request to update a display of a time measured inside the time measurement device 1. For example, the event is a request to update a display of a time point measured inside the time measurement device 1.

The event may be an event caused outside the time measurement device 1.

For example, the event is a request for predetermined processing for each operated button after an operation of the button 30 is received.

For example, the event is a request for predetermined processing inside the time measurement device 1 that occurs after communication from a device outside the time measurement device 1 is received inside the time measurement device 1. For example, the event is a request for predetermined display update processing that occurs after the wireless communication circuit 104 receives wireless communication from a device outside the time measurement device 1.

For example, an event is a request for predetermined processing that occurs along with a change in an internal or external state of the time measurement device 1.

The polarity reversal cycle may be a non-integer multiple of a constant cycle at which the display on the liquid crystal panel 301 is updated due to a specific function of the time measurement device 1. For example, the polarity reversal cycle is set to a value of a non-integral multiple of a constant cycle in which a time point measured by the time measurement device 1 is displayed. For example, the polarity reversal cycle is set to a value of a non-integral multiple of a constant cycle for displaying a time measured by the time measurement device 1 (for example, a time measured by a stopwatch). For example, when a cycle of updating the display of the time point is 1 Hz, the polarity reversal cycle is set to a non-integral multiple value from 0.91 times to 0.99 times 1 Hz. For example, when a cycle of blinking the display of time such as the time point is 8 Hz, the polarity reversal cycle is set to a non-integral multiple value from 7.28 times to 7.92 times 8 Hz. For example, when a cycle of updating the display of the time measured by the stopwatch is 10 Hz, the polarity reversal cycle is set to a non-integral multiple value from 9.1 times to 9.9 times 10 Hz. Accordingly, when the event is an event caused outside the time measurement device 1, it is possible to reduce a possibility that a timing of the polarity reversal of the AC voltage applied to the liquid crystal panel 301 overlaps a timing of the update of the display, that is, a timing of an output of the image data. The non-integral multiple value is not a level of value caused by a frequency deviation of the crystal oscillator 20 or the oscillator 10. For example, the cycle of 0.99 seconds, which is obtained by setting the polarity reversal cycle to 0.99 times 1 Hz, differs from 1.0 second by 328 cycles of a cycle of 32768 Hz of the oscillation circuit 101, is larger than the frequency deviation, and is in a range controllable to a desired value.

The event holding unit 122 holds the event received by the event reception unit 121 in a period of a certain first standby operation time immediately before the polarity of the AC voltage applied to the liquid crystal panel 301 is reversed and a certain second standby operation time immediately after the polarity of the AC voltage is reversed. The event holding unit 122 is, for example, a hardware interrupt generation function in the first control unit 105 or an event queue.

The first standby operation time includes one unit of time for writing image data to the liquid crystal panel 301 and an image data writing inhibition time immediately before the polarity of the AC voltage applied to the liquid crystal panel 301 is reversed. In the present embodiment, the first standby operation time is a total time of the one unit of time for writing image data to the liquid crystal panel 301 and the image data writing inhibition time immediately before the polarity of the AC voltage applied to the liquid crystal panel 301 is reversed.

The one unit of time of writing the image data to the liquid crystal panel 301 is a time required for one write operation, which is the one write operation of transmitting an address indicating a display position on the liquid crystal panel 301, transmitting the image data, and transmitting a write command once or repeatedly a plurality of times. An example of one unit of image data writing to the liquid crystal panel 301 is one row of an array of a plurality of pixels in a display region of the liquid crystal panel 301.

The second standby operation time includes an image data writing inhibition time immediately after the polarity of the AC voltage applied to the liquid crystal panel 301 is reversed. In the present embodiment, the second standby operation time is an image data writing inhibition time immediately after the polarity of the AC voltage applied to the liquid crystal panel 301 is reversed.

The display update determination unit 123 determines whether the event requires updating of the display on the liquid crystal panel 301. After the period of the first standby operation time and the second standby operation time elapse, the display update determination unit 123 determines whether the holding event requires updating of the display on the liquid crystal panel 301.

The image data output control unit 124 writes, to the liquid crystal panel 301, image data of an event for which it is determined that the updating of the display on the liquid crystal panel 301 is required. The image data output control unit 124 writes, to the liquid crystal panel 301 after a period of the second standby operation time elapses, a portion not being completely written to the liquid crystal panel 301 by an end of a period of the first standby operation time among the image data of the event for which it is determined that the updating of the display on the liquid crystal panel 301 is required.

The second control device 200 includes an oscillation circuit 201, a frequency divider circuit 202, a timer circuit 203, a 1 kHz counter circuit 204, the second control unit 205, a ROM 206, a RAM 207, an input circuit 208, a communication circuit 209, and the N output circuits 210.

The oscillation circuit 201 generates a signal having a predetermined frequency based on a signal having a frequency generated by the crystal oscillator 20. The frequency divider circuit 202 divides the signal having the predetermined frequency generated by the oscillation circuit 201 to generate a signal having an operation frequency of the second control device 200. The frequency divider circuit 202 divides the signal having the predetermined frequency generated by the oscillation circuit 201 to generate a signal having an operation frequency of the 1 kHz counter circuit 204. The frequency divider circuit 202 generates a 1 Hz interrupt signal required to update a time point display. The frequency divider circuit 202 generates an 8 Hz interrupt signal required for a blinking display such as during time point correction. An operation of the frequency divider circuit 202 is reset by a reset signal from the second control unit 205 by, for example, a time point second adjustment operation. Since the timer circuit 103 is not reset at this time, a timing at which the polarity of the VCOM signal is reversed does not change.

The timer circuit 203 uses the signal having the predetermined frequency generated by the oscillation circuit 201 to measure a predetermined timer time. The timer circuit 203 generates a hardware interrupt “timer interrupt” to the second control unit 205 at the time of completion of measurement of the predetermined timer time. The 1 kHz counter circuit 204 generates 1 kHz from 2048 Hz generated by the frequency divider circuit 202, performs decimal counting, and generates a 10 Hz interrupt signal and a 1 Hz interrupt signal for the 1 kHz counter circuit 204 required for updating a display of the stopwatch. The 10 Hz interrupt signal and the 1 Hz interrupt signal for the 1 kHz counter circuit 204 generate respective hardware interrupts to the second control unit 205.

The second control unit 205 mainly has a function of controlling time measurement among the control functions of the time measurement device 1. The second control unit 205 includes a CPU and achieves various functions by executing programs stored in the ROM 206. The second control unit 205 includes the time point timing unit 221 and the stopwatch (STW) measurement unit 222 as functional units.

The ROM 206 stores programs executed by the CPU of the second control unit 205 and data such as default values of various parameters. The RAM 207 is a memory for temporarily storing data used by the second control unit 205.

The time point timing unit 221 measures a time point. The STW timing unit 222 measures a time of a stopwatch.

The input circuit 208 receives a signal indicating a state of the button 30 operated by a user. The communication circuit 209 communicates with the first control device 100. The communication circuit 209 transmits, for example, timing data to the first control device 100. The output circuit 210 outputs a signal to the corresponding input circuit 110 of the first control device 100. For example, a certain output circuit 210 outputs a display update timing signal to the corresponding input circuit 110 of the first control device 100. For example, a certain output circuit 210 outputs a button input notification signal to the corresponding input circuit 110 of the first control device 100.

Next, an operation of the time measurement device 1 according to the present embodiment will be described.

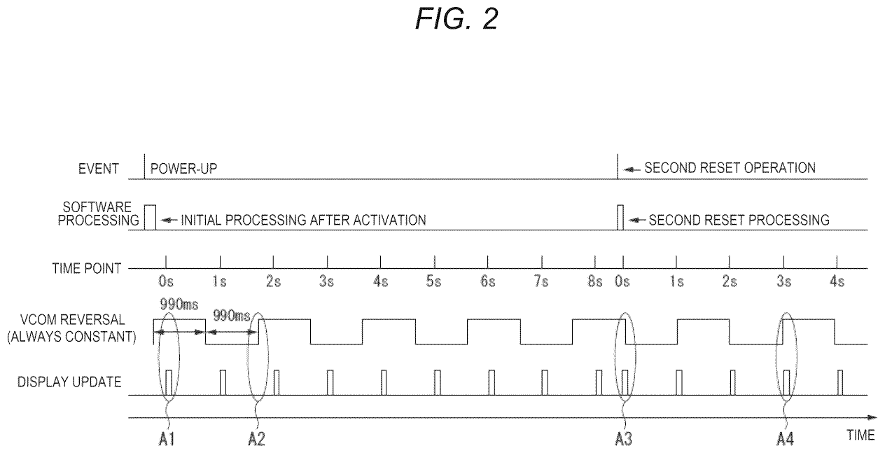

An operation example of the time measurement device 1 according to the present embodiment will be described with reference to FIGS. 2 to 6. FIGS. 2 to 6 are time charts illustrating operation examples of the time measurement device 1 according to the present embodiment.

### Operation Example A1

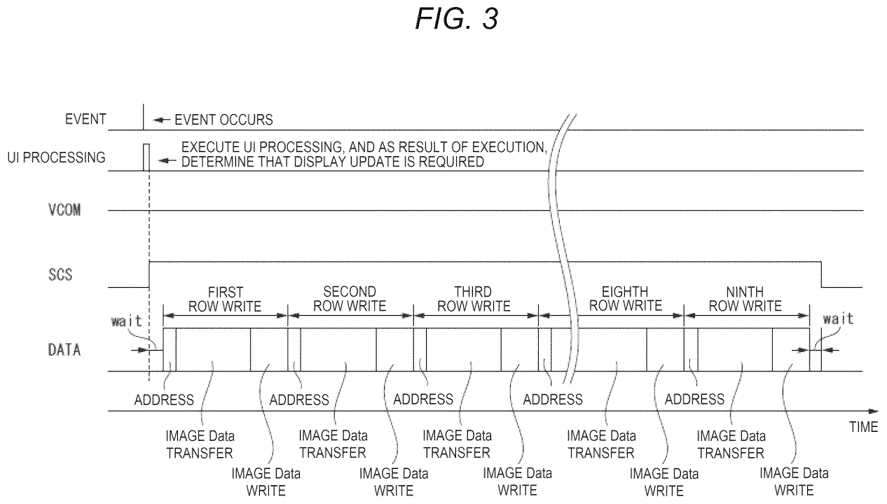

In the operation example A1 in FIG. 2, the polarity of the VCOM signal is not reversed during the update of the display of the liquid crystal panel 301. In the operation example A1, as illustrated in FIG. 3, when an event occurs, since it is not a period of the first standby operation time and the second standby operation time, it is immediately determined that an event that occurs requires updating of the display on the liquid crystal panel 301, and image data is written to the liquid crystal panel 301.

In the present embodiment, writing the image data to the liquid crystal panel 301 is performed by transmitting the address indicating the display position on the liquid crystal panel 301, transmitting the image data, and transmitting the write command once or repeatedly a plurality of times as one write operation, and by continuously performing the one write operation a plurality of times, the image data to be simultaneously displayed in a display region of the liquid crystal panel 301 is written. In the example in FIG. 3, the image data to be simultaneously displayed on first to ninth rows of the display region of the liquid crystal panel 301 is written to the liquid crystal panel 301 by continuously performing the write operation in units of one row nine times.

### Operation Example A2

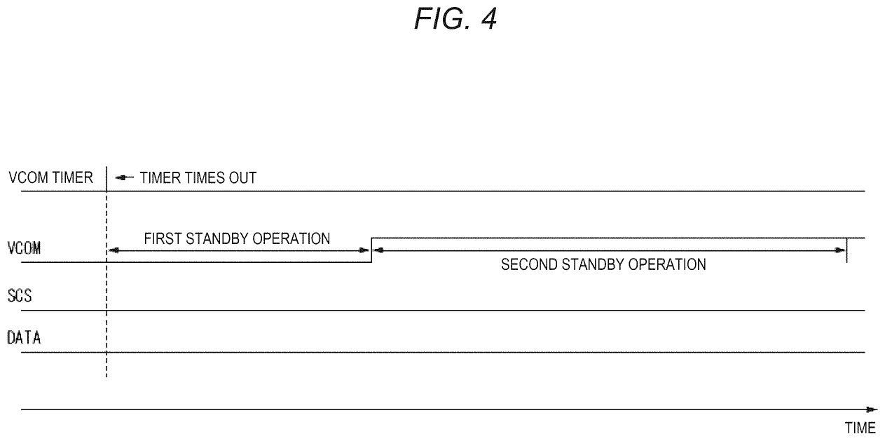

In the operation example A2 in FIG. 2, the display of the liquid crystal panel 301 is not updated during the reversal of the polarity of the VCOM signal. In the operation example A2, as illustrated in FIG. 4, when a VCOM timer that measures a constant polarity reversal cycle times up, the polarity of the VCOM signal is reversed after waiting for the first standby operation time. When the polarity of the VCOM signal is reversed, the processing waits for the second standby operation time. After one unit time of the image data writing elapses immediately after the start of the period of the first standby operation time and during the second standby operation time, writing of the image data to the liquid crystal panel 301 is forcibly inhibited by setting a chip select signal SCS to the liquid crystal panel 301 inactive (LOW).

### Operation Example A3

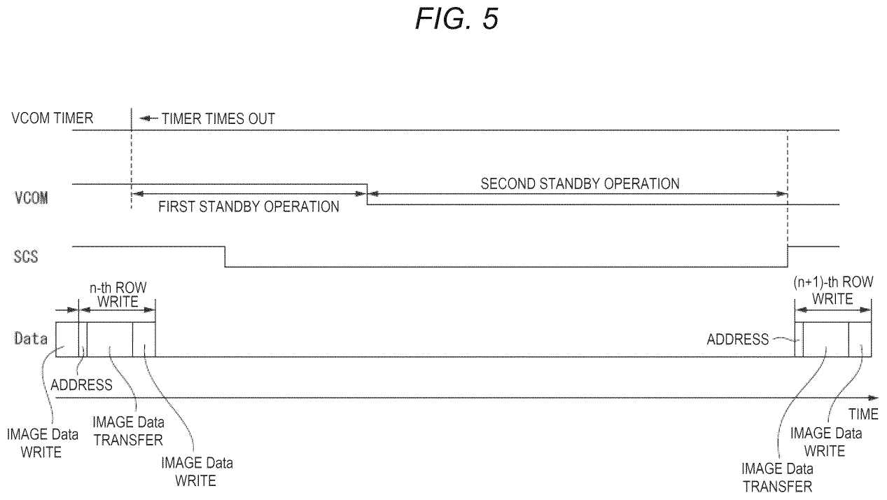

In the operation example A3 in FIG. 2, the polarity of the VCOM signal is reversed during the update of the display of the liquid crystal panel 301. In the operation example A3, as illustrated in FIG. 5, among the image data of the event for which it is determined that updating of the display on the liquid crystal panel 301 is required, the writing of the image data up to an n-th row to the liquid crystal panel 301 is completed by an end of the period of the first standby operation time, but the writing of the image data from an “n+1”-th row onwards to the liquid crystal panel 301 is not completed by the end of the period of the first standby operation time. The writing of the image data from the “n+1”-th row onwards, which is a portion of the image data in which the writing to the liquid crystal panel 301 is not completed by the end of the period of the first standby operation time, is written to the liquid crystal panel 301 after the period of the second standby operation time elapses.

Among the image data of the event for which it is determined that the updating of the display on the liquid crystal panel 301 is required, a portion of the image data (the image data up to the n-th row in the example in FIG. 5) in which the writing to the liquid crystal panel 301 is completed by the end of the period of the first standby operation time and a portion of the image data (the image data from the “n+1”-th row onwards in the example in FIG. 5) to be written to the liquid crystal panel 301 after the period of the second standby operation time elapses are written to different addresses in the liquid crystal panel 301.

Among the image data of the event for which it is determined that the updating of the display on the liquid crystal panel 301 is required, a portion of the image data (the image data up to the n-th row in the example in FIG. 5) in which the writing to the liquid crystal panel 301 is completed by the end of the period of the first standby operation time and a portion of the image data (the image data from the “n+1”-th row onwards in the example in FIG. 5) to be written to the liquid crystal panel 301 after the period of the second standby operation time elapses are displayed in different parts on the display region of the liquid crystal panel 301.

When transmitting the address indicating the display position on the liquid crystal panel 301, transmitting the image data, and transmitting the write command once or repeatedly a plurality of times are regarded as the one write operation, and when a timing for reversing the polarity of the AC voltage applied to the liquid crystal panel 301 arrives during the one write operation that is continuously performed a plurality of times, the one write operation currently performed (the write operation of the image data of the n-th row in the example in FIG. 5) is completed, and the remaining one or more of the one write operations (the write operation of the image data from the “n+1”-th row onwards in the example in FIG. 5) are performed after the period of the second standby operation time elapses.

### Operation Example A4

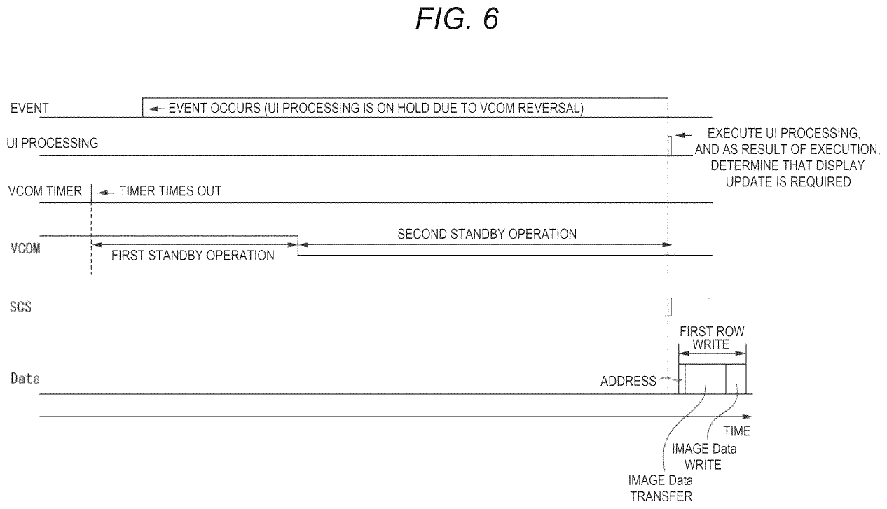

The operation example A4 in FIG. 2 is a case where an event including updating of the display of the liquid crystal panel 301 occurs during reversal of the polarity of the VCOM signal. In the operation example A4, as illustrated in FIG. 6, even if an event occurs, the event is put on hold in the periods of the first standby operation time and the second standby operation time. Next, after the periods of the first standby operation time and the second standby operation time elapse, it is determined whether the holding event requires updating of the display on the liquid crystal panel 301. Next, the image data of the event for which it is determined that the updating of the display on the liquid crystal panel 301 is required is written to the liquid crystal panel 301. The writing to the liquid crystal panel 301 is performed after the period of the second standby operation time elapses.

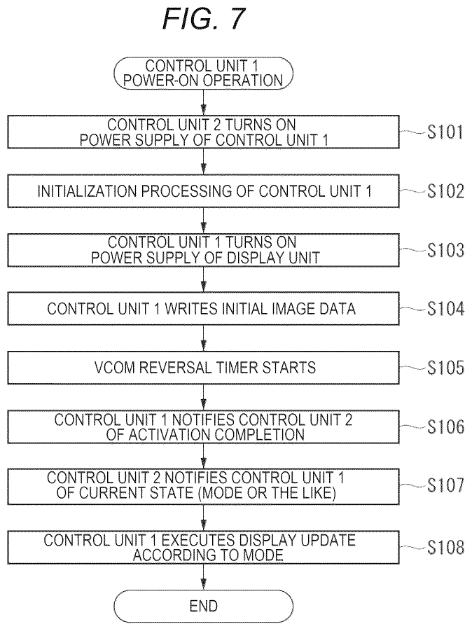

A flow of processing executed by the time measurement device 1 according to the present embodiment will be described with reference to FIGS. 7 to 16. FIGS. 7 to 16 are diagrams illustrating processing flows executed by the time measurement device 1 according to the present embodiment. Hereinafter, the first control unit 105 may be referred to as a “control unit 1”, and the second control unit 205 may be referred to as a “control unit 2”.

### Processing Flow Related to Power-On of Control Unit 1

The processing flow related to the power-on of the first control unit 105 will be described with reference to FIG. 7. FIG. 7 is a diagram illustrating the processing flow related to the power-on of the first control unit 105 according to the present embodiment.
(Step S101) The control unit 2 turns on a power supply of the control unit 1.
(Step S102) The control unit 1 executes its own initialization processing.
(Step S103) The control unit 1 turns on a power supply of the display module 300 (display unit).
(Step S104) The image data output control unit 124 of the control unit 1 writes initial image data to the liquid crystal panel 301. The initial image data is, for example, image data without full-screen display.
(Step S105) The polarity control unit 125 of the control unit 1 starts a timer (VCOM timer) for reversing the polarity of the VCOM signal. The VCOM timer is a timer that measures a constant polarity reversal cycle.
(Step S106) The control unit 1 notifies the control unit 2 of completion of its activation.
(Step S107) The control unit 2 notifies the control unit 1 of a current state (mode or the like) of each function and a current time point.
(Step S108) The control unit 1 executes a predetermined update of the display on the liquid crystal panel 301 according to the mode of the function. For example, when the current mode is a time point display mode, the current time point is displayed.

### Processing Flow Related to Power-Off of Control Unit 1

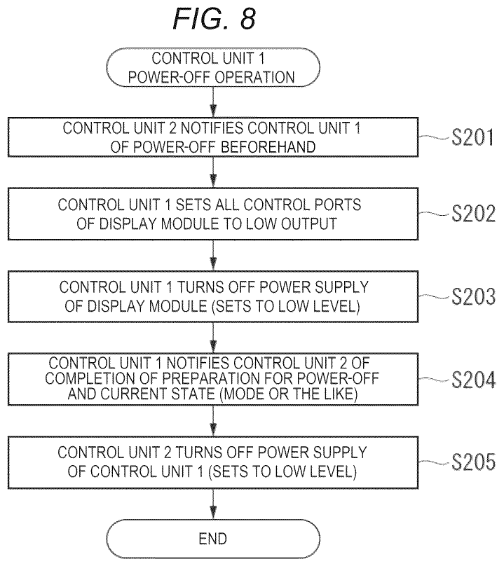

The processing flow related to the power-off of the first control unit 105 will be described with reference to FIG. 8. FIG. 8 is a diagram illustrating the processing flow related to the power-off of the first control unit 105 according to the present embodiment.
(Step S201) The control unit 2 notifies the control unit 1 of power-off beforehand.
(Step S202) The control unit 1 sets all control ports of the display module 300 to inactive output (LOW output).
(Step S203) The control unit 1 turns off the power supply of the display module 300.
(Step S204) The control unit 1 notifies the control unit 2 of completion of preparations for the power-off and a current state (mode or the like) of each function.
(Step S205) The control unit 2 turns off the power supply of the control unit 1.

### Processing Flow Related to Reversal of Polarity of VCOM Signal

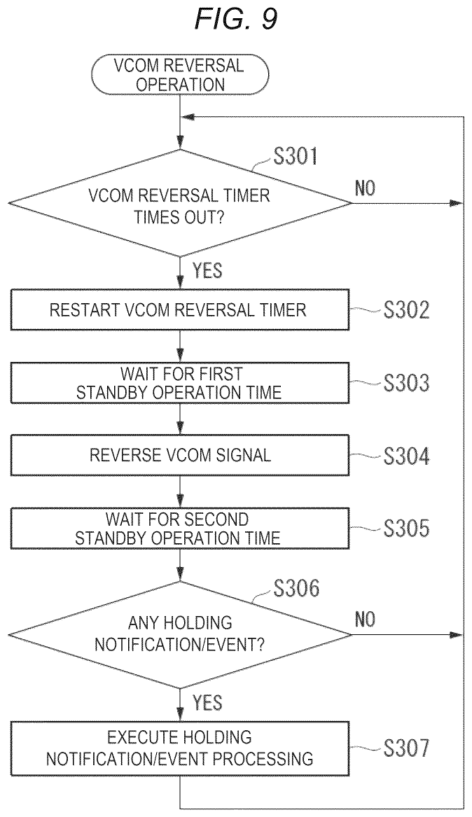

The processing flow related to the reversal of the polarity of the VCOM signal will be described with reference to FIG. 9. FIG. 9 is a diagram illustrating a processing flow related to reversal of the polarity of the VCOM signal according to the present embodiment.
(Step S301) The polarity control unit 125 of the control unit 1 determines whether the VCOM timer times out. If the VCOM timer times out, the processing proceeds to step S302. If the VCOM timer does not time out, step S301 is continued.
(Step S302) The polarity control unit 125 restarts the VCOM timer.
(Step S303) The polarity control unit 125 waits for the first standby operation time.
(Step S304) The polarity control unit 125 reverses the polarity of the VCOM signal after the first standby operation time elapses.
(Step S305) The polarity control unit 125 waits for the second standby operation time.
(Step S306) The polarity control unit 125 checks whether there is a holding event. Specifically, it is checked whether there is an event registered in holding event information described later. The event registered in the holding event information is “holding event”. When there is a holding event (when there is an event registered in the holding event information), the processing proceeds to step S307, and when there is no holding event (when there is no event registered in the holding event information), the processing returns to step S301.
(Step S307) The display update determination unit 123 of the control unit 1 determines whether the holding event requires updating of the display on the liquid crystal panel 301. If the holding event requires updating of the display on the liquid crystal panel 301, the image data output control unit 124 of the control unit 1 writes image data of the holding event to the liquid crystal panel 301.

### Processing Flow Related to Updating of Display on Liquid Crystal Panel

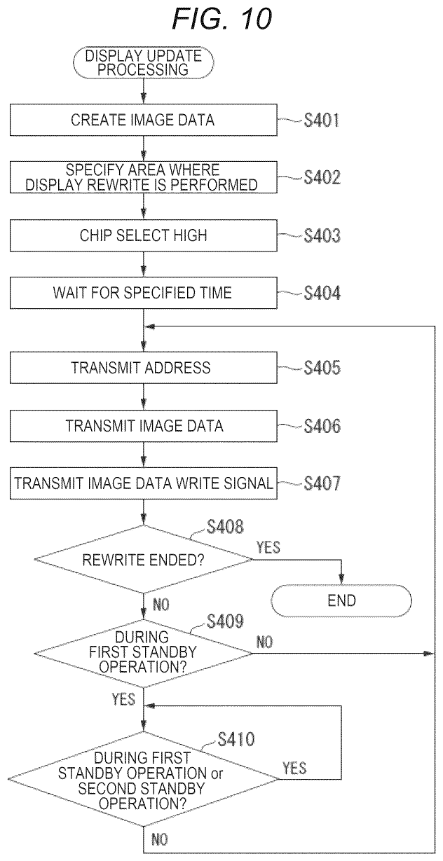

A processing flow related to the updating of the display on the liquid crystal panel 301 will be described with reference to FIG. 10. FIG. 10 is a diagram illustrating the processing flow related to the updating of the display of the liquid crystal panel 301 according to the present embodiment.
(Step S401) The image data output control unit 124 of the control unit 1 creates image data of an event that requires updating of display on the liquid crystal panel 301.
(Step S402) The image data output control unit 124 specifies an area in the display region of the liquid crystal panel 301 where the display is to be updated (an area (address) where image data is to be rewritten).
(Step S403) The image data output control unit 124 makes the chip select signal SCS to the liquid crystal panel 301 active (HIGH).
(Step S404) The image data output control unit 124 waits for a specified waiting time immediately after making the chip select signal SCS active (HIGH).
(Step S405) The image data output control unit 124 transmits an address indicating a display position on the liquid crystal panel 301.
(Step S406) The image data output control unit 124 transmits image data.
(Step S407) The image data output control unit 124 transmits an image data write signal (write command).
(Step S408) The image data output control unit 124 determines whether writing of all the image data of the event is completed. If the writing of all the image data of the event is completed, the processing of FIG. 10 ends. Meanwhile, if there is image data that is not written, the processing proceeds to step S409.
(Step S409) The image data output control unit 124 determines whether the state is during the period of the first standby operation time. If the state is during the period of the first standby operation time, the processing proceeds to step S410. Meanwhile, if the state is not during the period of the first standby operation time, the processing proceeds to step S405 to write image data that is not written to the liquid crystal panel 301.
(Step S410) The image data output control unit 124 determines whether the state is during the period of the first standby operation time or the second standby operation time. If the state is during the period of the first standby operation time or the second standby operation time (step S410, YES), the processing waits until the period of the first standby operation time and the second standby operation time end. Meanwhile, if the periods of the first standby operation time and the second standby operation time end (step S410, NO), the processing proceeds to step S405 to write image data that is not written to the liquid crystal panel 301.

### Processing Flow Related to Time Point Count

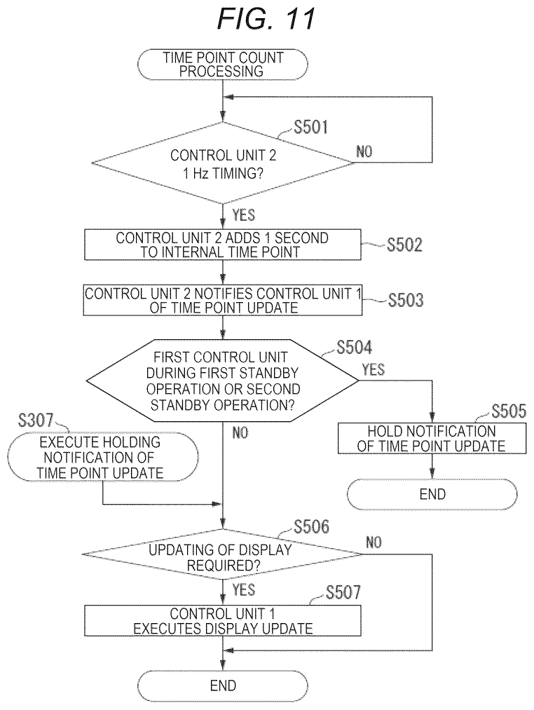

The processing flow related to time point count will be described with reference to FIG. 11. FIG. 11 is a diagram illustrating the processing flow related to the time point count according to the present embodiment.
(Step S501) The time point timing unit 221 of the control unit 2 determines whether a 1 Hz interrupt signal occurs. If the 1 Hz interrupt signal occurs (step S501, YES), the processing proceeds to step S502. If the 1 Hz interrupt signal does not occur (step S501, NO), step S501 is continued.
(Step S502) The time point timing unit 221 adds 1 second to a holding time point (internal time point).
(Step S503) The time point timing unit 221 notifies the control unit 1 of a time point update. The event reception unit 121 of the control unit 1 receives the notification of time point update (event) from the control unit 2.
(Step S504) The display update determination unit 123 of the control unit 1 determines whether the state is during the period of the first standby operation time or the second standby operation time. If the state is during the period of the first standby operation time or the second standby operation time (step S504, YES), the processing proceeds to step S505. Meanwhile, if the state is not during the period of the first standby operation time and the second standby operation time (step S504, NO), the processing proceeds to step S506.
(Step S505) The event holding unit 122 of the control unit 1 holds an event “notification of time point update” received by the event reception unit 121. Specifically, the event “notification of time point update” is registered in the holding event information. Thereafter, when the period of the second standby operation time ends, in step S306 in FIG. 9, it is determined that there is a holding event, and the processing proceeds to step S307, where the processing proceeds to step S506 in FIG. 11 to execute the notification of time point update which is holding notification/event processing.
(Step S506) The display update determination unit 123 determines whether the event “notification of time point update” received by the event reception unit 121 requires updating of the display on the liquid crystal panel 301. If it is determined that the updating of the display on the liquid crystal panel 301 is required, the processing proceeds to step S507. For example, when a current display is a time point display, it is determined that the updating of the display on the liquid crystal panel 301 is required. Meanwhile, if it is determined that the updating of the display on the liquid crystal panel 301 is not required, the processing in FIG. 11 ends. For example, when the current display does not include the time point display, it is determined that the updating of the display on the liquid crystal panel 301 is not required.
(Step S507) The image data output control unit 124 of the control unit 1 executes the display update processing (FIG. 10) for the event “notification of time point update” for which it is determined that the updating of the display on the liquid crystal panel 301 is required.

### Processing Flow Related to Button Operation

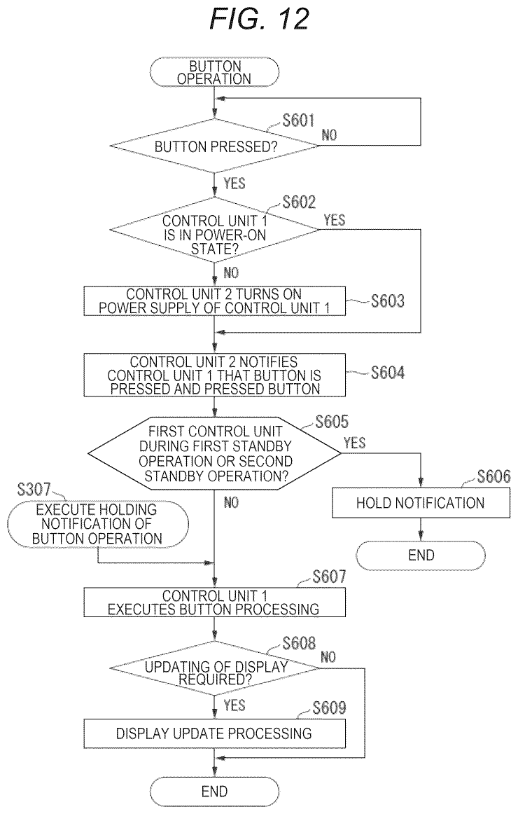

The processing flow related to the button operation will be described with reference to FIG. 12. FIG. 12 is a diagram illustrating the processing flow related to the button operation according to the present embodiment.
(Step S601) The control unit 2 determines whether the button 30 is pressed (whether the button 30 is operated). If it is determined that the button 30 is pressed, the processing proceeds to step S602. Meanwhile, if it is not determined that the button 30 is pressed, step S601 is continued.
(Step S602) The control unit 2 determines whether the control unit 1 is in a power-on state. If the control unit 1 is in the power-on state, the processing proceeds to step S604. Meanwhile, if the control unit 1 is not in the power-on state, the processing proceeds to step S603.
(Step S603) The control unit 2 turns on a power supply of the control unit 1.
(Step S604) The control unit 2 notifies the control unit 1 that the button 30 is pressed and information specifying the pressed button 30. The event reception unit 121 of the control unit 1 receives a notification of a button operation (event) from the control unit 2.
(Step S605) The display update determination unit 123 of the control unit 1 determines whether the state is during the period of the first standby operation time or the second standby operation time. If the state is during the period of the first standby operation time or the second standby operation time (step S605, YES), the processing proceeds to step S606. Meanwhile, if the state is not during the period of the first standby operation time and the second standby operation time (step S605, NO), the processing proceeds to step S607.
(Step S606) The event holding unit 122 of the control unit 1 holds the event “notification of button operation” received by the event reception unit 121. Specifically, the event “notification of button operation” is registered in the holding event information. Thereafter, when the period of the second standby operation time ends, in step S306 in FIG. 9, it is determined that there is a holding event, and the processing proceeds to step S307, where the processing proceeds to step S607 in FIG. 12 to execute the notification of button operation which is the holding notification/event processing.
(Step S607) The control unit 1 executes predetermined button processing for each operated button indicated by the event “notification of button operation”.
(Step S608) The display update determination unit 123 of the control unit 1 determines whether the event “notification of button operation” received by the event reception unit 121 requires updating of the display on the liquid crystal panel 301. If it is determined that the updating of the display on the liquid crystal panel 301 is required, the processing proceeds to step S609. For example, in a case of a button operation for switching a display mode, it is determined that the updating of the display on the liquid crystal panel 301 is required. Meanwhile, if it is determined that the updating of the display on the liquid crystal panel 301 is not required, the processing in FIG. 12 ends. For example, in a case of a button operation to start turning on backlight illumination, it is determined that the updating of the display on the liquid crystal panel 301 is not required.
(Step S609) The image data output control unit 124 of the control unit 1 executes the display update processing (FIG. 10) for the event “notification of button operation” for which it is determined that the updating of the display on the liquid crystal panel 301 is required.

### Processing Flow Related to Stopwatch (STW) Timing

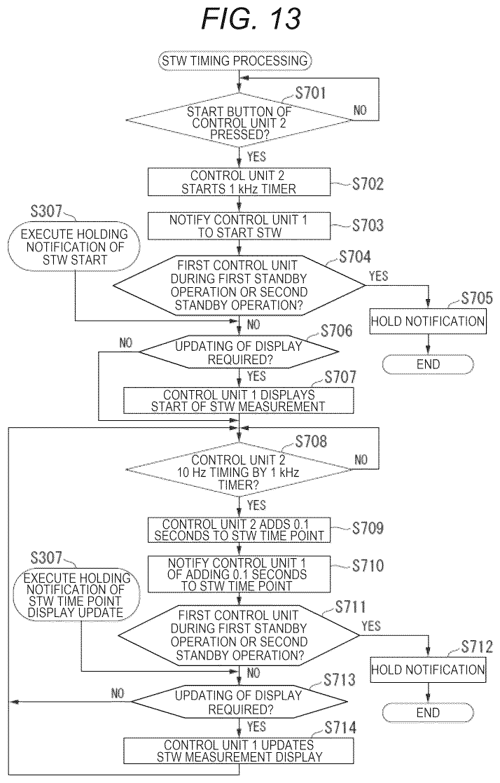

The processing flow related to the stopwatch timing will be described with reference to FIG. 13. FIG. 13 is a diagram illustrating the processing flow related to the stopwatch timing according to the present embodiment.
(Step S701) The STW timing unit 222 of the control unit 2 determines whether the button 30 (STW start button 30) for instructing a user to start the stopwatch is pressed (whether the STW start button 30 is operated). If it is determined that the STW start button 30 is pressed, the processing proceeds to step S702. Meanwhile, if it is not determined that the STW start button 30 is pressed, step S701 is continued.
(Step S702) The STW timing unit 222 starts a 1 kHz timer.
(Step S703) The STW timing unit 222 notifies the control unit 1 of the start of the stopwatch. The event reception unit 121 of the control unit 1 receives a notification of stopwatch start (event) from the control unit 2.
(Step S704) The display update determination unit 123 of the control unit 1 determines whether the state is during the period of the first standby operation time or the second standby operation time. If the state is during the period of the first standby operation time or the second standby operation time (step S704, YES), the processing proceeds to step S705. Meanwhile, if the state is not during the period of the first standby operation time and the second standby operation time (step S704, NO), the processing proceeds to step S706.
(Step S705) The event holding unit 122 of the control unit 1 holds the event “notification of stopwatch start” received by the event reception unit 121. Specifically, the event “notification of stopwatch start” is registered in the holding event information. Thereafter, when the period of the second standby operation time ends, in step S306 in FIG. 9, it is determined that there is a holding event, and the processing proceeds to step S307, where the processing proceeds to step S706 in FIG. 13 to execute the notification of stopwatch start which is the holding notification/event processing.
(Step S706) The display update determination unit 123 determines whether the event “notification of stopwatch start” received by the event reception unit 121 requires updating of the display on the liquid crystal panel 301. If it is determined that the updating of the display on the liquid crystal panel 301 is required, the processing proceeds to step S707. For example, if there is an icon indicating an operation state of the stopwatch, it is determined that the updating of the display on the liquid crystal panel 301 is required. Meanwhile, if it is determined that the updating of the display on the liquid crystal panel 301 is not required, the processing proceeds to step S708. For example, if there is no icon indicating the operation state of the stopwatch and a measurement unit is 1 second, a next display update timing is 1 second later, and thus it is determined that the updating of the display on the liquid crystal panel 301 is not required.
(Step S707) The image data output control unit 124 of the control unit 1 executes the display update processing (FIG. 10) for the event “notification of stopwatch start” for which it is determined that the updating of the display on the liquid crystal panel 301 is required. Accordingly, information indicating start of measurement of the stopwatch is displayed on the liquid crystal panel 301.
(Step S708) The STW timing unit 222 of the control unit 2 determines whether a timing is a 10 Hz timing by a 1 kHz timer. If it is determined to be the 10 Hz timing, the processing proceeds to step S709. Meanwhile, if it is not determined to be the 10 Hz timing, step S708 is continued.
(Step S709) The STW timing unit 222 adds 0.1 seconds to the holding stopwatch time point (STW time point).
(Step S710) The STW timing unit 222 notifies the control unit 1 of the display update of the STW time point (adding 0.1 seconds to the STW time point). The event reception unit 121 of the control unit 1 receives the notification of STW time point display update (event) from the control unit 2.
(Step S711) The display update determination unit 123 of the control unit 1 determines whether the state is during the period of the first standby operation time or the second standby operation time. If the state is during the period of the first standby operation time or the second standby operation time (step S711, YES), the processing proceeds to step S712. Meanwhile, if the state is not during the period of the first standby operation time and the second standby operation time (step S711, NO), the processing proceeds to step S713.
(Step S712) The event holding unit 122 of the control unit 1 holds the event “notification of STW time point display update” received by the event reception unit 121. Specifically, the event “notification of STW time point display update” is registered in the holding event information. Thereafter, when the period of the second standby operation time ends, in step S306 in FIG. 9, it is determined that there is a holding event, and the processing proceeds to step S307, where the processing proceeds to step S713 in FIG. 13 to execute the notification of STW time point display update which is the holding notification/event processing.
(Step S713) The display update determination unit 123 determines whether the event “notification of STW time point display update” received by the event reception unit 121 requires updating of the display on the liquid crystal panel 301. If it is determined that the updating of the display on the liquid crystal panel 301 is required, the processing proceeds to step S714. For example, when the measurement unit of the stopwatch is 0.1 seconds, it is determined that the updating of the display on the liquid crystal panel 301 is required. Meanwhile, if it is determined that the updating of the display on the liquid crystal panel 301 is not required, the processing returns to step S708. For example, when the measurement unit of the stopwatch is 1 second and there is no change in a displayed measurement value (changes to 0.8 seconds), it is determined that the updating of the display on the liquid crystal panel 301 is not required.
(Step S714) The image data output control unit 124 of the control unit 1 executes the display update processing (FIG. 10) for the event “notification of STW time point display update” for which it is determined that the updating of the display on the liquid crystal panel 301 is required. Accordingly, the time point of the stopwatch displayed on the liquid crystal panel 301 is updated. After step S714, the processing returns to step S708.

### Processing Flow Related to Stopwatch (STW) Reset

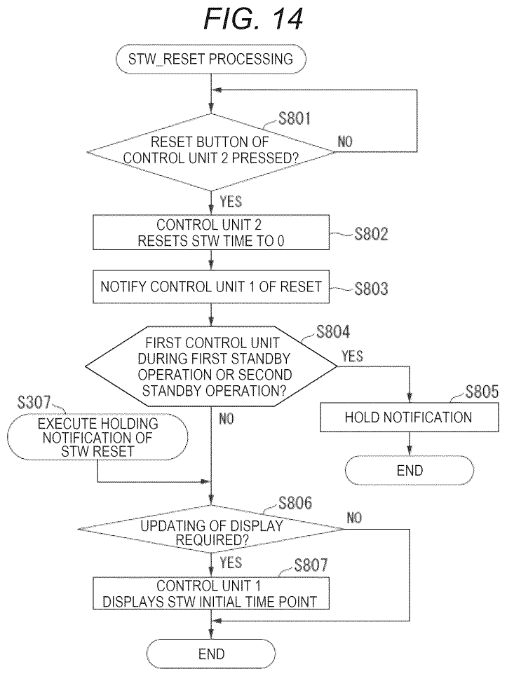

The processing flow related to the stopwatch reset will be described with reference to FIG. 14. FIG. 14 is a diagram illustrating the processing flow related to the stopwatch reset according to the present embodiment.
(Step S801) The STW timing unit 222 of the control unit 2 determines whether the button 30 (STW reset button 30) for instructing a user to reset the stopwatch is pressed (whether the STW reset button 30 is operated). If it is determined that the STW reset button 30 is pressed, the processing proceeds to step S802. Meanwhile, if it is not determined that the STW reset button 30 is pressed, step S801 is continued.
(Step S802) The STW timing unit 222 resets the STW time point to 0 (resets the 1 kHz counter circuit 204).
(Step S803) The STW timing unit 222 notifies the control unit 1 of the stopwatch reset. The event reception unit 121 of the control unit 1 receives a notification of stopwatch reset (event) from the control unit 2.
(Step S804) The display update determination unit 123 of the control unit 1 determines whether the state is during the period of the first standby operation time or the second standby operation time. If the state is during the period of the first standby operation time or the second standby operation time (step S804, YES), the processing proceeds to step S805. Meanwhile, if the state is not during the period of the first standby operation time and the second standby operation time (step S804, NO), the processing proceeds to step S806.
(Step S805) The event holding unit 122 of the control unit 1 holds the event “notification of stopwatch reset” received by the event reception unit 121. Specifically, the event “notification of stopwatch reset” is registered in the holding event information. Thereafter, when the period of the second standby operation time ends, in step S306 in FIG. 9, it is determined that there is a holding event, and the processing proceeds to step S307, where the processing proceeds to step S806 in FIG. 14 to execute the notification of stopwatch reset which is the holding notification/event processing.
(Step S806) The display update determination unit 123 determines whether the event “notification of stopwatch reset” received by the event reception unit 121 requires updating of the display on the liquid crystal panel 301. If it is determined that the updating of the display on the liquid crystal panel 301 is required, the processing proceeds to step S807. For example, when the measurement value of the stopwatch is changed, it is determined that the updating of the display on the liquid crystal panel 301 is required. Meanwhile, if it is determined that the updating of the display on the liquid crystal panel 301 is not required, the processing in FIG. 14 ends. For example, when the measurement unit of the stopwatch is 1 second and the measurement value is less than 1 second, it is determined that the updating of the display on the liquid crystal panel 301 is not required.
(Step S807) The image data output control unit 124 of the control unit 1 executes the display update processing (FIG. 10) for the event “notification of stopwatch reset” for which it is determined that the updating of the display on the liquid crystal panel 301 is required. Accordingly, an initial time point of the stopwatch is displayed on the liquid crystal panel 301.

### Processing Flow Related to Stopwatch (STW) Split

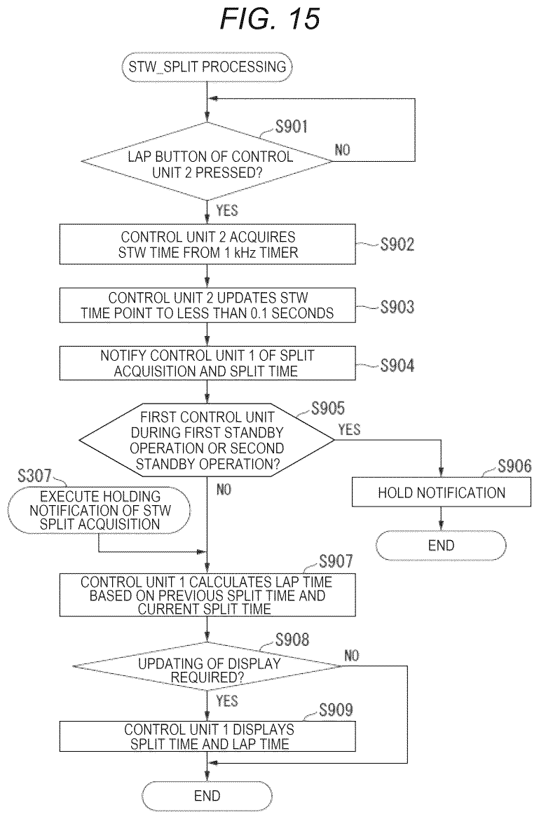

The processing flow related to the stopwatch split will be described with reference to FIG. 15. FIG. 15 is a diagram illustrating the processing flow related to the stopwatch split according to the present embodiment.
(Step S901) The STW timing unit 222 of the control unit 2 determines whether the button 30 (STW split button 30) for instructing a user of split of the stopwatch is pressed (whether the STW split button 30 is operated). If it is determined that the STW split button 30 is pressed, the processing proceeds to step S902. Meanwhile, if it is not determined that the STW split button 30 is pressed, step S901 is continued.
(Step S902) The STW timing unit 222 acquires a STW time point from the 1 kHz timer.
(Step S903) The STW timing unit 222 updates the STW time point to less than 0.1 seconds.
(Step S904) The STW timing unit 222 notifies split acquisition and a split time point to the control unit 1. The event reception unit 121 of the control unit 1 receives a notification of split acquisition (event) from the control unit 2.
(Step S905) The display update determination unit 123 of the control unit 1 determines whether the state is during the period of the first standby operation time or the second standby operation time. If the state is during the period of the first standby operation time or the second standby operation time (step S905, YES), the processing proceeds to step S906. Meanwhile, if the state is not during the period of the first standby operation time and the second standby operation time (step S905, NO), the processing proceeds to step S907.
(Step S906) The event holding unit 122 of the control unit 1 holds the event “notification of split acquisition” received by the event reception unit 121. Specifically, the event “notification of split acquisition” is registered in the holding event information. Thereafter, when the period of the second standby operation time ends, in step S306 in FIG. 9, it is determined that there is a holding event, and the processing proceeds to step S307, where the processing proceeds to step S907 in FIG. 15 to execute the notification of split acquisition of the stopwatch which is the holding notification/event processing.
(Step S907) The control unit 1 calculates a lap time based on a previously acquired split time point and a currently acquired split time point.
(Step S908) The display update determination unit 123 determines whether the event “notification of split acquisition” received by the event reception unit 121 requires updating of the display on the liquid crystal panel 301. If it is determined that the updating of the display on the liquid crystal panel 301 is required, the processing proceeds to step S909. For example, when the measurement unit of the stopwatch is 0.1 seconds, it is determined that the updating of the display on the liquid crystal panel 301 is required. Meanwhile, if it is determined that the updating of the display on the liquid crystal panel 301 is not required, the processing in FIG. 15 ends. For example, when the measurement unit of the stopwatch is 1 second and there is no change in the displayed measurement value (change of less than 1 second, such as 0.8 seconds), it is determined that the updating of the display on the liquid crystal panel 301 is not required.
(Step S909) The image data output control unit 124 of the control unit 1 executes the display update processing (FIG. 10) for the event “notification of split acquisition” for which it is determined that the updating of the display on the liquid crystal panel 301 is required. Accordingly, the currently acquired split time point and lap time of the stopwatch are displayed on the liquid crystal panel 301.

### Processing Flow Related to Stopwatch (STW) Stop

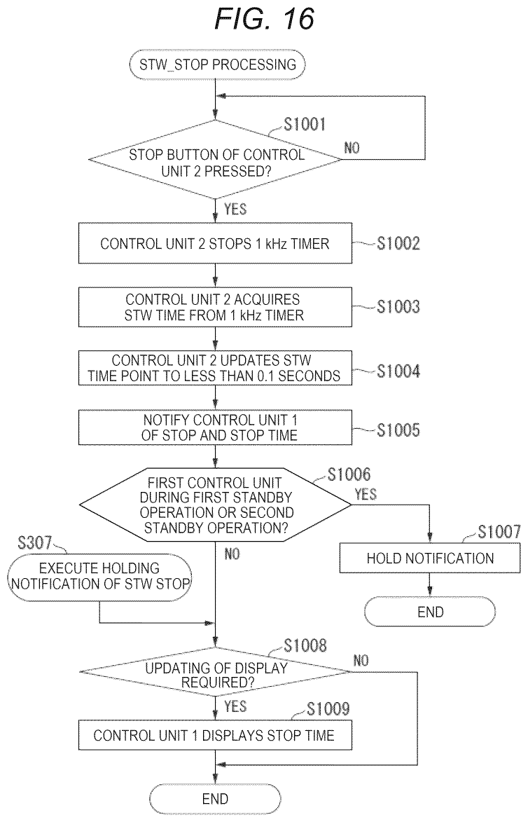

The processing flow related to the stopwatch stop will be described with reference to FIG. 16. FIG. 16 is a diagram illustrating the processing flow related to the stopwatch stop according to the present embodiment.
(Step S1001) The STW timing unit 222 of the control unit 2 determines whether the button 30 (STW stop button 30) for instructing a user to stop the stopwatch is pressed (whether the STW stop button 30 is operated). If it is determined that the STW stop button 30 is pressed, the processing proceeds to step S1002. Meanwhile, if it is not determined that the STW stop button 30 is pressed, step S1001 is continued.
(Step S1002) The STW timing unit 222 stops the 1 kHz timer.
(Step S1003) The STW timing unit 222 acquires a STW time point from the 1 kHz timer.
(Step S1004) The STW timing unit 222 updates the STW time point to less than 0.1 seconds.
(Step S1005) The STW timing unit 222 notifies the control unit 1 of the stop of the stopwatch and the STW time point (stop time) at the stop. The event reception unit 121 of the control unit 1 receives a notification of stopwatch stop (event) from the control unit 2.
(Step S1006) The display update determination unit 123 of the control unit 1 determines whether the state is during the period of the first standby operation time or the second standby operation time. If the state is during the period of the first standby operation time or the second standby operation time (step S1006, YES), the processing proceeds to step S1007. Meanwhile, if the state is not during the period of the first standby operation time and the second standby operation time (step S1006, NO), the processing proceeds to step S1008.
(Step S1007) The event holding unit 122 of the control unit 1 holds the event “notification of stopwatch stop” received by the event reception unit 121. Specifically, the event “notification of stopwatch stop” is registered in the holding event information. Thereafter, when the period of the second standby operation time ends, in step S306 in FIG. 9, it is determined that there is a holding event, and the processing proceeds to step S307, where the processing proceeds to step S1008 in FIG. 16 to execute the notification of stopwatch stop which is the holding notification/event processing.
(Step S1008) The display update determination unit 123 determines whether the event “notification of stopwatch stop” received by the event reception unit 121 requires updating of the display on the liquid crystal panel 301. If it is determined that the updating of the display on the liquid crystal panel 301 is required, the processing proceeds to step S1009. For example, when the measurement value of the stopwatch is updated, it is determined that the updating of the display on the liquid crystal panel 301 is required. Meanwhile, if it is determined that the updating of the display on the liquid crystal panel 301 is not required, the processing in FIG. 16 ends. For example, when the measurement unit of the stopwatch is 1 second and there is no change in the displayed measurement value (change of less than 1 second, such as 0.8 seconds), it is determined that the updating of the display on the liquid crystal panel 301 is not required.
(Step S1009) The image data output control unit 124 of the control unit 1 executes the display update processing (FIG. 10) for the event “notification of stopwatch stop” for which it is determined that the updating of the display on the liquid crystal panel 301 is required. Accordingly, a stop time is displayed on the liquid crystal panel 301.

According to the present embodiment, the event received by the event reception unit 121 is held in the period of the certain first standby operation time immediately before the polarity of the VCOM signal is reversed and the certain second standby operation time immediately after the polarity of the VCOM signal is reversed, and after the periods of the first standby operation time and the second standby operation time elapse, it is determined whether the holding event requires updating of the display on the liquid crystal panel 301, and the image data of the event for which it is determined that the updating of the display on the liquid crystal panel 301 is required is written to the liquid crystal panel 301. Therefore, since it is not necessary to perform processing of determining whether the period for transferring the image data is in a transfer standby period for reversing the polarity of the AC voltage applied to the liquid crystal panel 301, software can have a simple configuration.

According to the present embodiment, the duty ratio in the positive and negative periods of the AC voltage of the VCOM signal can be set to 50%, which contributes to maintaining the reliability of the liquid crystal of the liquid crystal panel 301.

According to the present embodiment, by setting the polarity reversal cycle of the VCOM signal to a value that is a non-integer multiple of a constant cycle at which the display on the liquid crystal panel 301 is updated due to a specific function of the time measurement device 1, it is possible to reduce a possibility that a timing of the polarity reversal of the AC voltage applied to the liquid crystal panel 301 and a timing of the update of the display, that is, a timing of an output of the image data overlap each other when the event is an event caused outside the time measurement device 1 (for example, a button operation by the user).

The time measurement device 1 may be provided in a digital electronic timepiece, a combination timepiece having a digital display function and a pointer display function, a stopwatch, or a timer.

In the configuration example in FIG. 1, a function of the time measurement device 1 is divided into the first control device 100 and the second control device 200, but the function of the time measurement device 1 may be achieved by one control device (one CPU) or may be achieved by two or more control devices (two or more CPUs).

In the configuration example in FIG. 1, the voltage conversion circuit 41 is configured to convert the voltage of the power supply 40 into the operation voltage of the first control device 100, the second control device 200, and the display module 300, but the first control device 100 and the second control device 200 may be directly driven by the power supply (battery) 40, and the voltage conversion circuit 41 may convert the voltage of the power supply 40 into only the operation voltage of the display module 300.

In the configuration example in FIG. 1, when the power supply of the control unit 1 is turned off, the control unit 1 notifies the control unit 2 of a current state (mode or the like), but a non-volatile memory may be added to the first control device 100, and the control unit 1 may store the current state (mode or the like) in the non-volatile memory.

In addition, a computer program for achieving the function of the time measurement device described above may be recorded on a computer-readable recording medium, and the program recorded on the recording medium may be read into a computer system and executed. The “computer system” here may include an OS and hardware such as peripheral devices.

The “computer-readable recording medium” refers to a writable non-volatile memory such as a flexible disk, a magneto-optical disk, a ROM, or a flash memory, a portable medium such as a digital versatile disc (DVD), or a storage device such as a hard disk built in the computer system.

Further, the “computer-readable recording medium” includes a medium that holds a program for a certain period of time, such as a volatile memory (for example, a dynamic random access memory (DRAM)) inside a computer system serving as a server or a client when the program is transmitted via a network such as the Internet or a communication line such as a telephone line.

The program may be transmitted from a computer system in which the program is stored in a storage device or the like to another computer system via a transmission medium, or by a transmission wave in the transmission medium. Here, the “transmission medium” that transmits the program refers to a medium having a function of transmitting information, such as a network (communication network) such as the Internet or a communication line such as a telephone line.

The program may be a program for achieving some of the functions described above. Further, the function may be achieved in combination with a program already recorded in the computer system, that is, a so-called differential file (differential program).

Although the embodiment of the invention has been described in detail with reference to the drawings, the specific configuration is not limited to the embodiment, and design changes and the like within a range not departing from the gist of the invention are also included.

What is claimed is:

1. A time measurement device having a time measurement function and displaying an image on a liquid crystal panel by writing image data to the liquid crystal panel, the time measurement device comprising:
a polarity control unit configured to reverse a polarity of an AC voltage applied to the liquid crystal panel at a constant polarity reversal cycle;
an event reception unit configured to receive an event that has a possibility to cause an update of a display on the liquid crystal panel;
an event holding unit configured to hold the event received by the event reception unit in periods of a certain first standby operation time immediately before the polarity of the AC voltage is reversed and a certain second standby operation time immediately after the polarity of the AC voltage is reversed;
a display update determination unit configured to determine whether the holding event requires updating of the display on the liquid crystal panel after the periods of the first standby operation time and the second standby operation time elapse; and
an image data output control unit configured to write, to the liquid crystal panel, image data of the event for which the updating of the display on the liquid crystal panel is determined to be required, wherein
the first standby operation time includes one unit of time for writing the image data to the liquid crystal panel and an image data writing inhibition time immediately before the polarity of the AC voltage is reversed, and
the second standby operation time includes an image data writing inhibition time immediately after the polarity of the AC voltage is reversed.

2. The time measurement device according to claim 1, wherein the image data output control unit writes, to the liquid crystal panel after the period of the second standby operation time elapses, a portion of the image data not being completely written to the liquid crystal panel by an end of the period of the first standby operation time among the image data of the event for which the updating of the display on the liquid crystal panel is determined to be required.

3. The time measurement device according to claim 2, wherein among the image data of the event for which the updating of the display on the liquid crystal panel is determined to be required, a portion of the image data in which writing to the liquid crystal panel is completed by the end of the period of the first standby operation time and a portion of the image data to be written to the liquid crystal panel after the period of the second standby operation time elapses are written to different addresses in the liquid crystal panel.

4. The time measurement device according to claim 2, wherein among the image data of the event for which the updating of the display on the liquid crystal panel is determined to be required, a portion of the image data in which writing to the liquid crystal panel is completed by the end of the period of the first standby operation time and a portion of the image data to be written to the liquid crystal panel after the period of the second standby operation time elapses are displayed in different parts on a display region of the liquid crystal panel.

5. The time measurement device according to claim 1, wherein the event is a request for predetermined processing inside the time measurement device that occurs after communication from a control unit having a predetermined control function inside the time measurement device is received inside the time measurement device.

6. The time measurement device according to claim 1, wherein the event is a request for predetermined processing activated by a hardware interrupt that occurs inside the time measurement device to a control unit having a predetermined control function inside the time measurement device.

7. The time measurement device according to claim 1, wherein the event is a request to update a display of a time measured inside the time measurement device.

8. The time measurement device according to claim 1, wherein the event is a request to update a display of a time point measured inside the time measurement device.

9. The time measurement device according to claim 1, wherein the polarity reversal cycle is a non-integer multiple of a constant cycle at which the display on the liquid crystal panel is updated due to a specific function of the time measurement device.

10. The time measurement device according to claim 9, wherein the event is a request for predetermined processing for each operated button in the time measurement device after an operation of the button is received.

11. The time measurement device according to claim 9, wherein the event is a request for predetermined processing inside the time measurement device that occurs after communication from a device outside the time measurement device is received inside the time measurement device.

12. The time measurement device according to claim 9, wherein the event is a request for predetermined processing that occurs along with a change in an internal or external state of the time measurement device.

13. The time measurement device according to claim 1, wherein
the writing of the image data to the liquid crystal panel is performed by transmitting an address indicating a display position on the liquid crystal panel, transmitting the image data, and transmitting a write command once or repeatedly a plurality of times as one write operation, and by continuously performing the one write operation a plurality of times, the image data to be simultaneously displayed in a display region of the liquid crystal panel is written, and
when a timing for reversing the polarity of the AC voltage arrives during the one write operation that is continuously performed a plurality of times, the one write operation currently performed is completed, and the remaining one or more of the one write operations are performed after the period of the second standby operation time elapses.

14. The time measurement device according to claim 1, wherein the time measurement device is provided in a digital electronic timepiece, a combination timepiece having a digital display function and a pointer display function, a stopwatch, or a timer.
